(19) United States
(12) Patent Application Publication
(10) Pub. No.: US 2011/0143317 A1
(43) Pub. Date: Jun. 16, 2011

(54) Straight Conic Mini Pillar Used in Outer Hexagon Implants

(76) Inventor: Geninho Thome, Curitiba (BR)

(21) Appl. No.: 13/001,691

(22) PCT Filed: Jun. 26, 2009
(86) PCT No.: PCT/BR09/00181

§ 371 Date: Feb. 22, 2011

(30) Foreign Application Priority Data
Jul. 3, 2008 (BR) MU8803977-6

(51) Int. Cl. A61C 13/225

(52) U.S. Cl. 433/172

(57) ABSTRACT

It is specifically a single body mini pillar, i e, a conic mini pillar body plus a fastening screw in a single piece, thus simplifying its installing process and superseding the model currently in use The new conic mini pillar prosthetic component has attained improvements on the screw region, obviating the furrow (channel), that previously generated product brittleness and also susceptible to fractures which are the clinical problems and difficult maintenance causes. With this evolution, the new conic mini pillar prosthetic component can endure higher installing torques around 32 N cm, in comparing with the prior model.

### BRIEF DESCRIPTION OF THE INVENTION

The subject utility model patent application concerns with an innovator straight conic mini pillar for outer hexagon implants. It is specifically a single body mini pillar, i.e., a conic mini pillar body plus a fastening screw in a single piece, thus simplifying its installing process and superseding the model currently in use.

### DESCRIPTION OF THE STATE OF THE ART AND EXISTENT PROBLEMS

Currently, the prosthetic conic mini pillar component is presented in two parts, i.e., a conic mini pillar plus a screw. With this presentation, the conic mini pillar screw needs a furrow (channel) in its body mid portion to prevent the occurrence of fractures in dental implant most inner parts thus jeopardizing future services. Due to this geometry, the assembly mechanic resistance can accept a maximum installing torque of 20 N.cm.

The conic mini pillar prosthetic component outer geometry has a divergent angle that starts from the base that fits over the dental implant until its larger platform where there is received the conic mini pillar cylinder prosthetic component. This divergent angle is called the transmucous height, and with this presentation there is created a pressure over the gum tissue that can eventually generate little edemas.

Furthermore, during the surgical procedure it is necessary the use of a countersink bit so the housing region of this conic mini pillar prosthetic component is manufactured, promoting a good quality removal of cervical bone.

Further, considering with economic issues, the conic mini pillar prosthetic component calls a manufacturing process that needs two times, i.e., the conic mini pillar body manufacturing and subsequently the conic mini pillar screw fabrication that fits thereat.

### UTILITY MODEL SUMMARY

The new conic mini pillar prosthetic component design is different from prior one as to its manufacture since now contemplates a single body prosthetic component, i.e., the conic mini pillar and the screw in a single piece.

### DESCRIPTION OF THE DRAWINGS

FIG. 1A illustrates a detail that shows the conic mini pillar prosthetic component currently marketed

FIG. 1B illustrates a detail that shows the conic mini pillar prosthetic component in its new conception.

FIG. 2 illustrates the currently marketed conic mini pillar prosthetic component.

FIG. 3 illustrates the conic mini pillar prosthetic component in its new conception in a single body.

FIG. 4 illustrates the conic mini pillar prosthetic component in its new conception in a single body with the currently marketed model overlaid.

### DESCRIPTION OF THE INVENTION

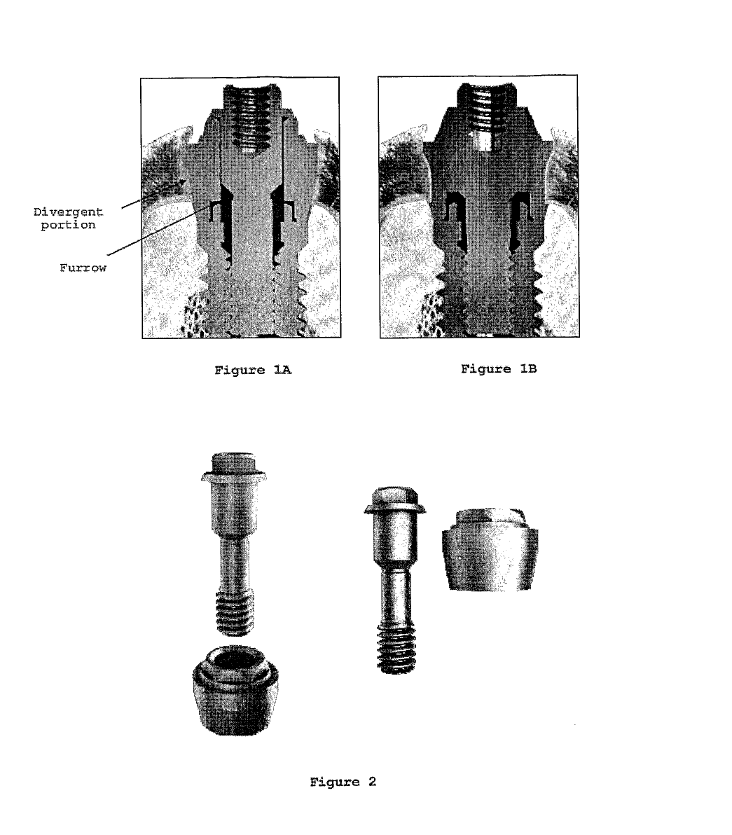

As of mechanical resistance issues, the new conic mini pillar prosthetic component has attained improvements on the screw region, obviating the furrow (channel), illustrated in FIG. 1A, that previously generated a product brittleness and also susceptible to fractures which are the clinical problems and difficult maintenance causes. With this evolution, the new conic mini pillar prosthetic component can endure higher installing torques around 32 N.cm, in comparing with the prior model.

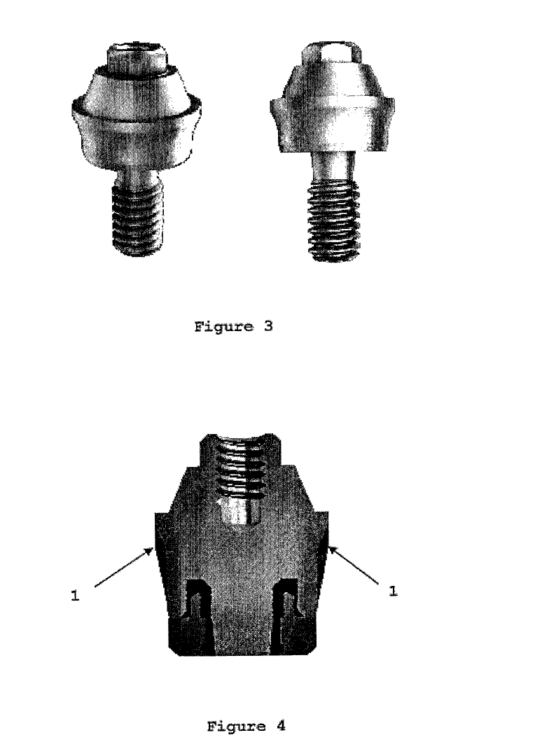

The new conic mini pillar prosthetic component outer geometry no longer has the prior divergent angle, as one can observe from FIG. 3. The new model then presents the transmucous height with the same dental implant prosthetic platform diameter that starts in its base that fits on the implant and now has the divergent profile only very close to the larger platform where the conic mini pillar prosthetic component cylinder will be received. In this way, pressures over the gum tissue can be avoided thus reducing edemas.

The now straight transmucous height can also obviate the use of the countersink bit preserving the good quality cervical bone portions in the dental implant prosthetic platform region.

FIG. 4 clearly illustrates the evolution between the current model and the new conception, wherein red portions (1) represent regions of pressure over the gum tissue that due to the new model are no longer to occur.

Such conic mini pillar is used as an intermediary between the intraorally placed outer hexagon implant and the planned prosthesis according to each case, components diameter and tolerance indication being respected aiming at aesthetics and function.

The morse cone mini pillar is machined from a biocompatible titanium alloy available as a sterile form for single use.

The morse cone mini pillar is packed in blisters packages (surgical grade film and paper) available as single units on the market.

The single body conic mini pillar will be available with varying height extents from 1, 2, 3, 4 and 5 millimeters (mm).

The respective mini pillar which is the object of the utility model patent in question, provides larger easiness in its installation over the implant since it does not need an additional screw to be fastened, thus providing a more precise fitting between the conic mini pillar and the implant, thus figuring as a new product on the congener market and bringing several benefits in its use.

It suits to clarify that the hereby presented model is illustrated in a demonstrative not !imitative way, which conception can be variable as measures, said enhancement can also be subject to diversifications as its dimensions and materials, without logically deviating from the main inventive scope of the object which protection is claimed.

In this way, the utility model patent concerns with a single body conic mini pillar that has facilitated its fastening over the implant, enables a larger torque application at installing and does not present a fastening screw brittleness which exists in the current model due to the furrow (channel) that the fastening screw body needs.

However, it remains clear that said product is in consonance with Article 9 of LPI Nr. 9279, in complying with all necessary and indispensable requisites of the patent application as a utility model.

Because of all these aspects, the current patent application object deserves a protection as a utility model, which is now pleaded.

1. Straight conic mini pillar used in outer hexagon implants, characterized in that it comprehends:
a single body prosthetic component that involves a conic mini pillar and a screw thus obviating the furrow (channel) in its body mid portion;
the ability to receive installing torques of about 32 N.cm;
an outer geometry that no longer has the divergent angle; and
a transmucous height straight profile with the same dental implant prosthetic platform that starts from the base that fits over the dental implant and then come to have the divergent profile only very close to the larger platform where there is received the conic mini pillar cylinder prosthetic component.
